(19) United States
(12) Patent Application Publication
(10) Pub. No.: US 2026/0196789 A1
(43) Pub. Date: Jul. 9, 2026

(54) ASSEMBLY AND DISASSEMBLY DEVICES FOR PLUGGABLE CARDS

(71) Applicant: Aivres Systems Inc., San Jose, CA (US)

(72) Inventor: TZU HUA CHEN, New Taipei City (TW)

(21) Appl. No.: 19/011,200

(22) Filed: Jan. 6, 2025

(51) Int. Cl. H01R 43/26; H01R 12/72; H01R 13/627

(52) U.S. Cl. CPC H01R 43/26; H01R 12/721; H01R 13/6273

(57) ABSTRACT

Devices and methods for assembling and disassembling pluggable cards are provided. In one aspect, a device includes a support frame having a first frame portion and a second frame portion. The first frame portion includes a first side and a second side that are opposite to each other, the first side of the first frame portion including a notch, the second side of the first frame portion being connected to the second frame portion. The device also includes rotatable arms, and each of the rotatable arms is coupled to the first frame portion and the second frame portion. The device further includes connection structures. Each of the rotatable arms is coupled to the first frame portion through a respective connection structure of the connection structures, and each of the rotatable arms is rotatable with respect to the second frame portion.

### BACKGROUND

With the development of server computing, operators need to repeatedly assemble and disassemble computer cards on the server motherboard during daily operations.

### SUMMARY

The present disclosure provides devices, apparatus, and methods for assembling and disassembling pluggable cards, e.g., memory cards such as Dual In-line Memory Modules (DIMMs).

One aspect of the present disclosure features a device that includes a support frame, rotatable arms, and connection structures. The support frame has a first frame portion and a second frame portion. The first frame portion includes a first side and a second side that are opposite to each other. The first side of the first frame portion includes a notch, the second side of the first frame portion is connected to the second frame portion. Each of the rotatable arms is coupled to the first frame portion and the second frame portion. Each of the rotatable arms is coupled to the first frame portion through a respective connection structure of the connection structures, where each of the rotatable arms is rotatable with respect to the second frame portion.

In some implementations, each of the rotatable arms is and movable with respect to the first frame portion.

In some implementations, the rotatable arms include two rotatable arms coupled to two opposite ends of the second frame portion, and where a distance of ends of the two rotatable arms varies when the two rotatable arms are rotating with respect to the two opposite ends of the second frame portion.

In some implementations, the support frame further includes one or more bridge structures coupled between the first frame portion and the second frame portion.

In some implementations, the first frame portion, the second frame portion, and the one or more bridge structures are integrated into a single piece to form the support frame.

In some implementations, each of the one or more bridge structures extends along a first direction, and the second side of the first frame portion is connected to the second frame portion by the one or more bridge structures along the first direction, and where the notch in the first side of first frame portion extends along a second direction perpendicular to the first direction, and the first frame portion includes two connection portions each extending along the first direction, where the two connection portions are at opposite ends of the first frame portion along the second direction, and the one or more bridge structures are between the two connection portions along the second direction.

In some implementations, the rotatable arms include two rotatable arms each including a through hole, where the one or more bridge structures include two bridge structures each including an inner connection hole, where each of the two connection portions includes an outer connection hole, and where each of the two rotatable arms is coupled to a corresponding connection portion of the first frame portion and to a corresponding bridge structure by a corresponding connection structure through the outer connection hole, the through hole, and the inner connection hole that are aligned with each other along the second direction.

In some implementations, the support frame includes a space for a user to hold the device, the space being defined by the first frame portion, the second frame portion, and the two bridge structures.

In some implementations, the corresponding connection structure includes a spring, a post, and a screw, and where the post of the corresponding connection structure extends sequentially through the outer connection hole, the through hole, and the inner connection hole along the second direction, and where the screw of the corresponding connection structure secures the corresponding connection structure to the support frame.

In some implementations, the spring of the corresponding connection structure is arranged between the through hole of the rotatable arm and the inner connection hole of the corresponding bridge structure, and where the rotatable arm is movable along the post of the corresponding connection structure with respect to the corresponding connection portion of the first frame portion and the corresponding bridge structure while the rotatable arm is rotating with respect to the second frame portion.

In some implementations, a degree of rotation of the rotatable arm is determined by a flexibility of the spring between the rotatable arm and the corresponding bridge structure, a distance between the rotatable arm and the corresponding bridge structure is adjustable by moving the screw on the post of the corresponding connection structure.

In some implementations, a diameter of the through hole of the rotatable arm is greater than a diameter of the post of the corresponding connection structure.

In some implementations, the spring of the corresponding connection structure is configured to reposition the rotatable arm with respect to the second frame portion.

In some implementations, a degree of rotation of the rotatable arm is limited by the spring of the corresponding connection structure.

In some implementations, the second frame portion includes two opposite ends along the second direction, each opposite end including a stabilizing hole, where the rotatable arms include two rotatable arms each including a rotating hole, and where the device further includes two stabilizing pins that connect the two rotatable arms to the second frame portion of the support frame, where each of the two stabilizing pins extends through the stabilizing hole of a corresponding end of the second frame portion and the rotating hole of a corresponding rotatable arm, and where a corresponding rotatable arm is configured to rotate around the stabilizing pin with respect to the second frame portion.

In some implementations, the device is configured for at least one of: assembling a pluggable card into a socket, or disassembling the pluggable card from the socket, where the socket includes two latches at opposite end of the socket, and the two latches are configured to lock the pluggable card in the socket.

In some implementations, the rotatable arms include two rotatable arms each having a first end coupled to the first frame portion, a middle part coupled to the second frame portion, and a second end having a tip and a slope surface extending from the tip, and where the slope surfaces of the two rotatable arms face to each other.

In some implementations, each of the two latches includes an inner end, an outer end, and a slope region between the inner end and the outer end, and where the device is configured to disassemble the pluggable card by using the tips of the two rotatable arms to push the slope regions of the two latches such that the pluggable card is unlocked by the two latches.

In some implementations, a first distance between the tips of the two rotatable arms is smaller than a second distance between the outer ends of the two latches of the socket and greater than a third distance between the inner ends of the two latches of the socket.

In some implementations, a difference between the first distance and the second distance is in a range from 1 mm to 3 mm, or a length of the slope region is in a range from 1 mm to 3 mm.

In some implementations, the notch of the first frame portion has: a length greater than a length of the pluggable card, a width greater than a width of the pluggable card, a depth smaller than a distance between an edge of the pluggable card and an adjacent peripheral circuit or component of the pluggable card.

In some implementations, the depth of the notch of the first frame portion is in a range from 1 mm to 2 mm.

In some implementations, the pluggable card includes a Dual in-line memory module (DIMM).

Another aspect of the present disclosure features a method of assembling a pluggable card into a socket by a device, the method includes placing the pluggable card on the socket; placing the device on the pluggable card, where the pluggable card is inserted in a notch of the device, and where the device includes a support frame having a first frame portion and a second frame portion, where the first frame portion includes a first side and a second side that are opposite to each other, the first side of the first frame portion including the notch, the second side of the first frame portion being connected to the second frame portion; pushing down the device to assemble the pluggable card on the socket; and removing the device from the pluggable card.

In some implementations, the socket includes two latches at opposite ends of the socket, and where pushing down the device to assemble the pluggable card on the socket includes pushing down the pluggable card by the device to close the two latches of the socket to lock the pluggable card into the socket.

A further aspect of the present disclosure features a method of disassembling a pluggable card from a socket by a device, the method includes placing the device on two latches of the socket that lock the pluggable card on the socket, the device including two rotatable arms; pushing down the device to open the two latches of the socket using the two rotatable arms to unlock the pluggable card from the socket; and removing the device.

In some implementations, each of the two latches includes an inner end, an outer end, and a slope region between the inner end and the outer end, and where each of the two rotatable arms includes a tip, where placing the device on the two latches of the socket includes: placing the tips of the two rotatable arms of the device in contact with the two latches of the socket, and where pushing down the device to open the two latches of the socket to unlock the pluggable card includes pushing down the device, where the two rotatable arms rotate outward to open the two latches of the socket.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1A is an exploded view of components of an example device for assembling and disassembling a pluggable card.

FIG. 1B is a perspective view of the example device of FIG. 1A.

FIG. 2A is a perspective view of an example pluggable card.

FIG. 2B is a perspective view of an example computer board having sockets to hold pluggable cards.

FIG. 3 illustrates a process of assembling a pluggable card into a socket by an example device.

FIGS. 4A-4D illustrate steps for assembling the pluggable card into the socket by the example device of FIG. 3.

FIG. 5 is a flow chart of an example process of a method for assembling a pluggable card into a socket by an example device.

FIG. 6 illustrates a process of disassembling a pluggable card from a socket by an example device.

FIGS. 7A-7D illustrate steps for disassembling the pluggable card from the socket by the example device of FIG. 6.

FIG. 8 is a flow chart of an example process of a method for disassembling a pluggable card from a socket by an example device.

Like reference numbers and designations in the various drawings indicate like elements.

### DETAILED DESCRIPTION

During the design phase of server computing, operators need to frequently assemble and disassemble pluggable cards such as memory cards (e.g., DIMMs) onto or from a server motherboard to optimize server performance. In the production phase, operators need to assemble an increased number of pluggable cards on the server motherboard to meet the growing demand and advancements in server computing. During the service phase, operators need to assemble and disassemble pluggable cards from the server motherboard for debugging purposes. The large number of repetitive assembly and disassembly processes can damage the pluggable cards and lead to longer server downtime. Therefore, a device that can both assemble and disassemble pluggable cards with a simplified process is desirable.

In one or more implementations of the present disclosure, an example device for assembling and disassembling pluggable cards is provided. The device includes a support frame having a first frame portion and a second frame portion. The first frame portion includes a first side and a second side that are opposite to each other, the first side of the first frame portion including a notch, the second side of the first frame portion being connected to the second frame portion. The device also includes rotatable arms, and each of the rotatable arms is coupled to the first frame portion and the second frame portion. The device further includes connection structures. Each of the rotatable arms is coupled to the first frame portion through a respective connection structure of the connection structures, and each of the rotatable arms is rotatable with respect to the second frame portion.

Implementations of the present disclosure can provide one or more of the following technical advantages and/or benefits. First, the device can be used for both assembling a pluggable card into a socket and disassembling the pluggable card from the socket, which can be much more convenient for a user (e.g., an operator such as a human or a robot) than using separated assembly and disassembly tools. The device with the combined assembly and disassembly functions can also be cost efficient. Second, a space is created between the first frame portion and the second frame portion for the user (e.g., using a human hand or a robot hand) to conveniently or easily hold the device during the assembly and disassembly process. Third, the notch on the first side of the first frame portion can be used to guide the direction of the pluggable card when assembling the pluggable card into a socket. The notch ensures good alignment between the pluggable card and the socket to prevent damage to the pluggable card during the assembly process. Fourth, the rotatable arms of the device can help to disassemble the pluggable card from the socket during the disassembly process. The rotatable arms are rotatable with respect to the second frame portion. The rotation of the rotatable arms can help to release the pluggable card from the socket during the disassembly process.

Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

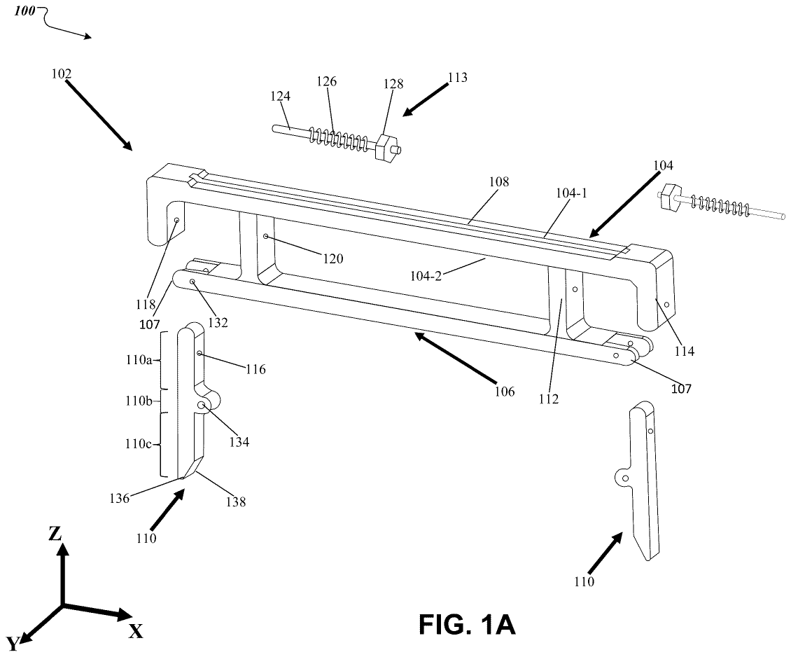

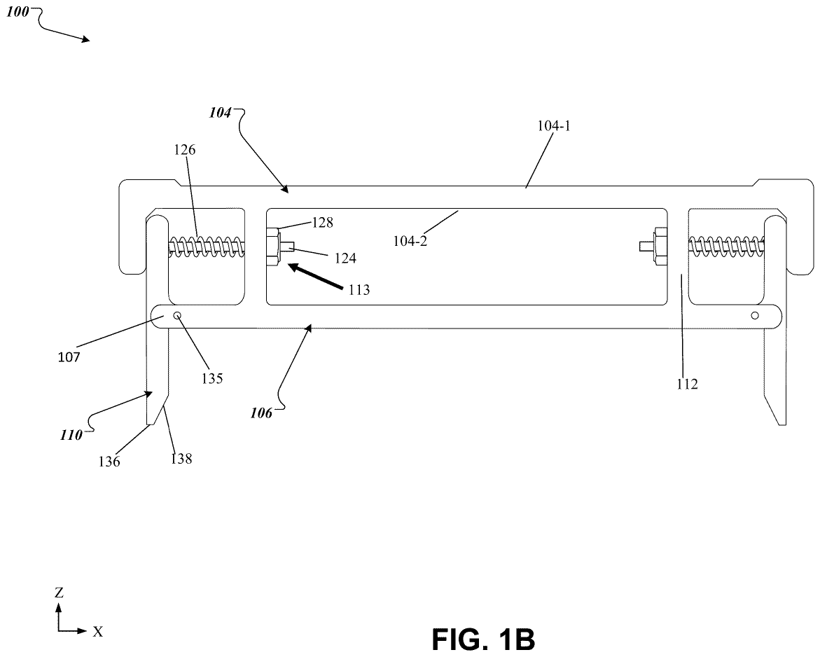

FIG. 1A is an exploded view of components of an example device 100 for assembling and disassembling a pluggable card. FIG. 1B is a perspective view of the example device 100 of FIG. 1A. The device 100 can be used to assemble a pluggable card onto a socket and disassemble the pluggable card from the socket.

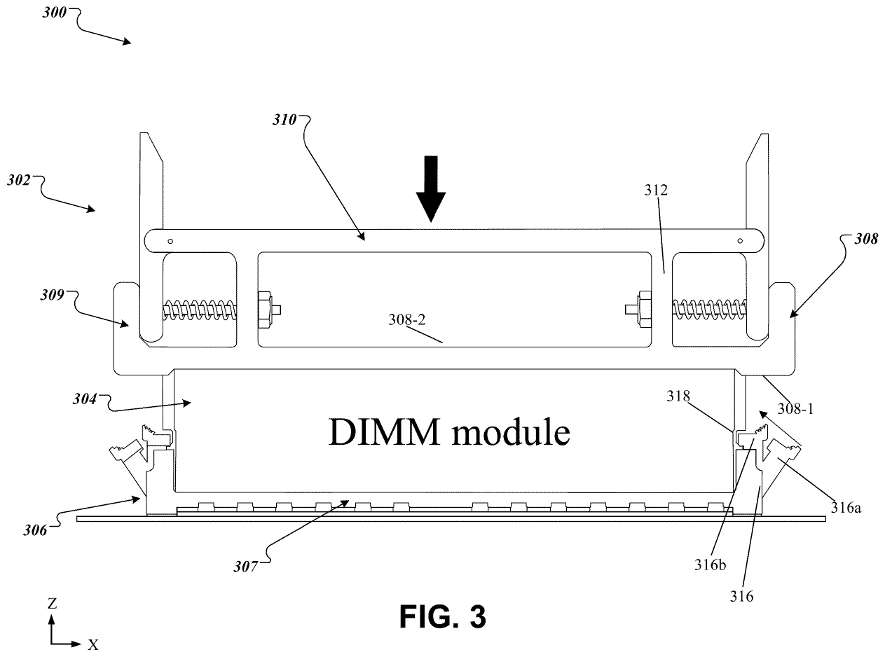

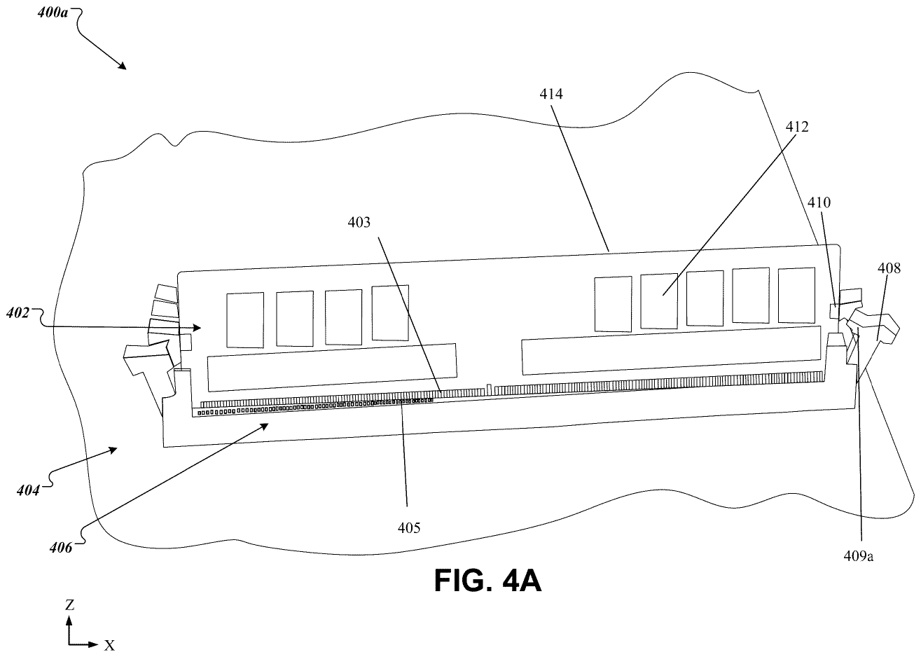

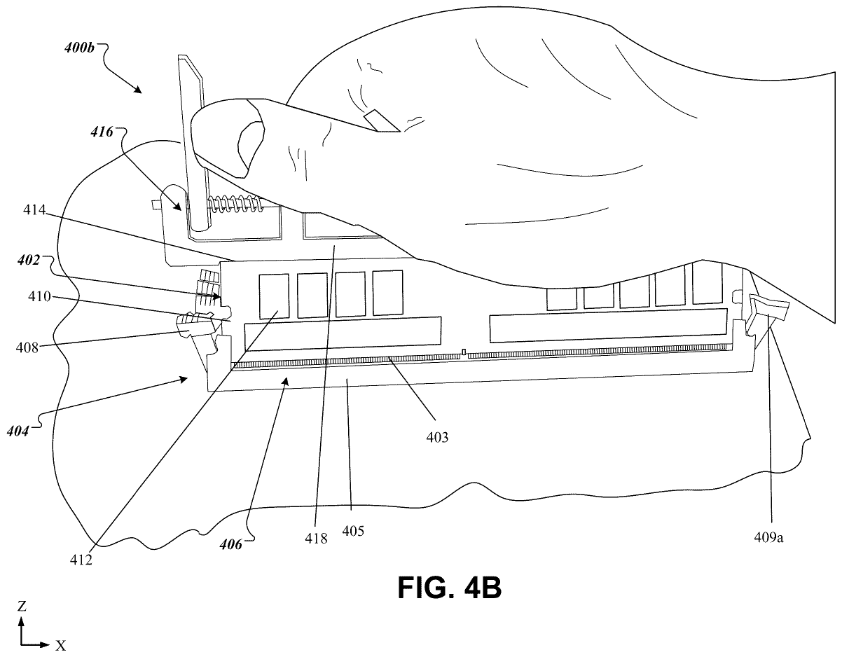

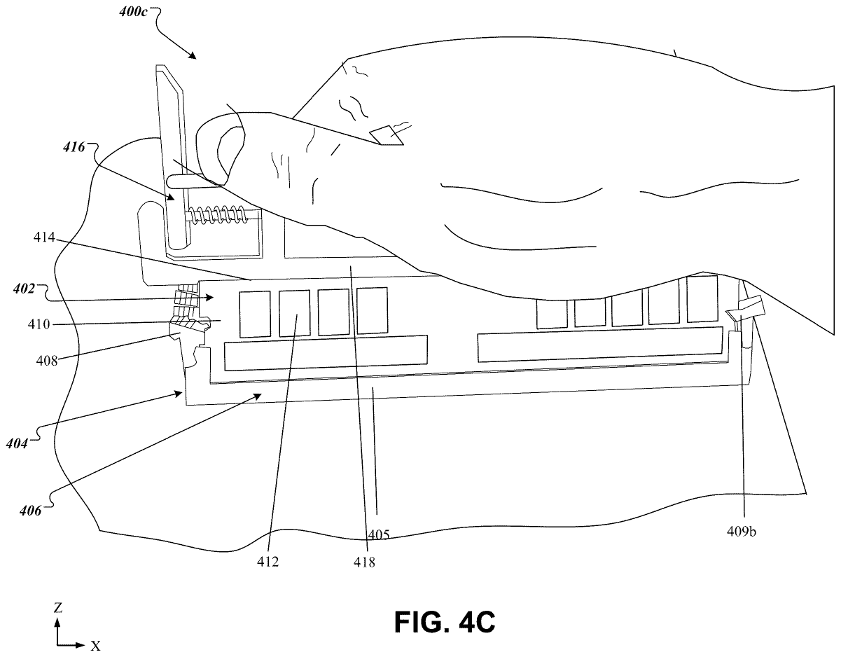

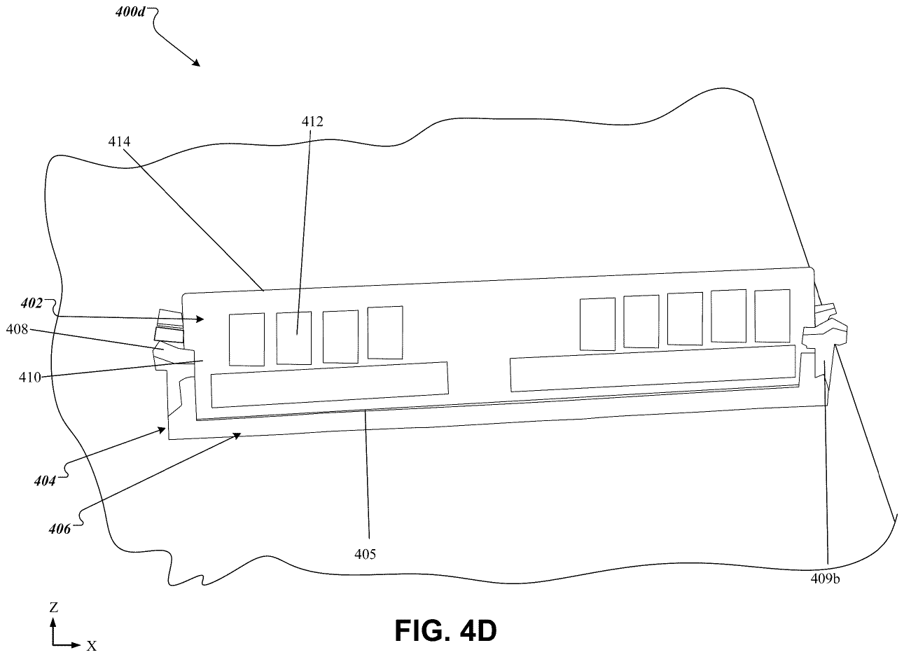

In some implementations, the pluggable card can be a computer card such as a memory card (e.g., a Dual in-line memory module (DIMM)). The socket can be a memory socket on a computer board (e.g., a motherboard). As shown in FIG. 1A, the device 100 can include a support frame 102 and rotatable arms 110. The support frame 102 can include a first frame portion 104 and a second frame portion 106. The first frame portion 104 has a first side 104-1 and a second side 104-2 that are opposite to each other along a vertical direction (e.g., the Z direction). The first side 104-1 of the first frame portion 104 includes a notch 108 and the second side 104-2 of the first frame portion 104 is connected to the second frame portion 106. In some implementations, the notch 108 can be used to hold the pluggable card in place while assembling the pluggable card into the socket. For example, during an assembling process of the pluggable card into the socket, a portion of the pluggable card is placed inside the notch 108, where the notch 108 holds the pluggable card in a fixed angle (e.g., vertical direction) respect to the socket during the assembling process, e.g., as illustrated with further details in FIGS. 3 and 4A-4D.

As shown in FIG. 1A, the support frame 102 includes one or more bridge structures 112 coupled between the first frame portion 104 and the second frame portion 106. The one or more bridge structures 112 are used to connect the first frame portion 104 and the second frame portion 106. As shown in FIG. 1A, each of the one or more bridge structures 112 extends along a first direction (e.g., Z direction), and the second side 104-2 of the first frame portion 104 is connected to the second frame portion 106 by the one or more bridge structures 112 along the first direction (e.g., Z direction). The notch 108 in the first side 104-1 of the first frame portion 104 extends along a second direction (e.g., the X direction) perpendicular to the first direction. In some implementations, the first frame portion 104, the second frame portion 106, and the one or more bridge structures 112 are integrated into a single piece to form the support frame 102, e.g., by 3D printing. For example, as shown in FIG. 1A, the support frame 102 includes two bridge structures 112 that extend along the first direction. The two bridge structures 112 are separated from each other along the second direction. In some implementation, the support frame 102 includes a space for a user (e.g., a human hand or a robot hand) to hold the device 100. The space is defined by the first frame portion 104, the second frame portion 106, and the two bridge structures 112. The second side 104-2 of the first frame portion 104 and the second frame portion 106 are connected by the two bridge structures 112 to form a single body of the support frame 102.

The first frame portion 104 also includes two connection portions 114. Each of the two connection portions 114 extends along the first direction. In some implementations, the two connection portions 114 are at opposite ends of the first frame portion along the second direction, and the one or more bridge structures 112 are between the two connection portions 114 along the second direction. As shown in FIG. 1A, each of the rotatable arms 110 includes a through hole 116. Each of the two connection portions 114 of the first frame portion 104 includes an outer connection hole 118. The one or more bridge structures 112 include two bridge structures 112 each including an inner connection hole 120. In some implementations, as shown in FIG. 1B, each of the rotatable arms 110 is coupled to the first frame portion 104 through a respective connection structure 113. For example, as shown in FIG. 1B, each of the two rotatable arms 110 is coupled to a corresponding connection portion 114 of the first frame portion 104 and to a corresponding bridge structure 112 by a corresponding connection structure 113 through an outer connection hole 118, the through hole 116 and an inner connection hole 120. In some implementations, as shown in FIG. 1B, the outer connection hole 118, the through hole 116 and the inner connection hole 120 are aligned with each other along the second direction.

The second frame portion 106 of the support frame 102 includes two opposite ends 107 along the second direction. Each opposite end 107 includes a stabilizing hole 132. Each of the rotatable arms 110 includes a rotating hole 134. As shown in FIG. 1B, the device 100 further includes two stabilizing pins 135 that connect the two rotatable arms 110 to the second frame portion 106 of the support frame 102. Each of the two stabilizing pins 135 extends through the stabilizing hole 132 of a corresponding end 107 of the second frame portion 106 and the rotating hole 134 of a corresponding rotatable arm 110. In some implementations, a corresponding rotatable arm 110 is configured to rotate around the stabilizing pin 135 with respect to the second frame portion 106.

As shown in FIG. 1A, the device 100 includes two rotatable arms 110 each having a first end 110a, a middle part 110b, and a second end 110c. In some implementations, as shown in FIG. 1B, the first end 110a of each of the two rotatable arms 110 is coupled to the first frame portion 104, the middle part 110b of each of the two rotatable arms 110 is coupled to the second frame portion 106, and the second end 110c of each of the two rotatable arms 110 includes a tip 136 and a slope surface 138 extending from the tip 136. In some implementations, the slope surfaces 138 of the two rotatable arms 110 face to each other, e.g., as illustrated in FIG. 1B.

FIG. 1B is a perspective view of the example device 100 of FIG. 1A. As shown in FIG. 1B, each of the rotatable arms 110 is coupled to the first frame portion 104 and the second frame portion 106 of the support frame 102. For example, each of the rotatable arms 110 is coupled to the first frame portion 104 through a respective connection structure 113 of the connection structures 113. The rotatable arm 110 is connected to the second frame portion 106 by a stabilizing pin 135. In some implementations, each of the rotatable arms 110 is rotatable with respect to the second frame portion 106. Each of the rotatable arms 110 is movable with respect to the first frame portion 104. For example, when the rotatable arm 110 rotates with respect to the second frame portion 106, the tip 136 of the rotatable arm 110 can rotate away from the support frame 102, and the first end 110a of the rotatable arm 110 moves toward a corresponding bridge structure 112 and the middle part 110b remains stationary respect to the stabilizing pin 135.

In some implementations, the device 100 can include two rotatable arms 110 coupled to two opposite ends 107 of the second frame portion 106. A distance of tips 136 of the two rotatable arms 110 varies when the two rotatable arms 110 are rotating with respect to the two opposite ends 107 of the second frame portion 106. For example, as shown in FIG. 1B, the tips 136 of the two rotatable arms 110 can move outward when the two rotatable arms 110 are rotating with respect to the second frame portion 106. In other words, a first distance between the tips 136 of the two rotatable arms 110 when the two rotatable arms 110 is at an initial position as shown in FIG. 1B is smaller than a second distance between the tips 136 of the two rotatable arms 110 when the two rotatable arms 110 rotate with respect to the second frame portion 106. In such a way, the device 100 can be used for disassembling computer cards with different sizes (e.g., lengths along the second direction).

In some implementations, the connection structure 113 includes a post 124, a spring 126, and a screw 128. In some implementations, the connection structure 113 couples a corresponding rotatable arm 110 to the first frame portion 104, where the post 124 of the corresponding connection structure 113 extends sequentially through the outer connection hole 118, the through hole 134, and the inner connection hole 120 along the second direction. As shown in FIG. 1B, the screw 128 of the corresponding connection structure 113 secures the corresponding connection structure 113 to the support frame 102. The spring 126 of the corresponding connection structure 113 is arranged between the through hole 134 of the rotatable arm 110 and the inner connection hole 120 of the corresponding bridge structure 112. In some implementations, the rotatable arm 110 is movable along the post 124 of the corresponding connection structure 113 with respect to the corresponding connection portion 114 of the first frame portion 104 and the corresponding bridge structure 112 while the rotatable arm 110 is rotating with respect to the second frame portion 106. In some implementations, a diameter of the through hole 134 of the rotatable arm 110 is greater than a diameter of the post 124 of the corresponding connection structure 113. The larger diameter of the through hole 134 of the rotatable arm 110 assists the movement of the rotatable arm 110 along the post 124 of the corresponding connection structure 113.

In some implementations, the degree of rotation of the rotatable arm 110 is determined by a flexibility of the spring 126 between the rotatable arm 110 and the corresponding bridge structure 112. The spring 126 of the corresponding connection structure 113 can be used to guide and limit the rotation of the rotatable arm 110 around the second frame portion 106 by preventing the movement of the rotatable arm 110 along the post 124 of the corresponding connection structure 113. In some implementations, the degree of rotation of the rotatable arm 110 is limited by the flexibility of the spring 126 of the corresponding connection structure 113. The degree of rotation of the rotatable arm 110 can be adjusted by adjusting the flexibility of the spring 126 between the rotatable arm 110 and the corresponding bridge structure 112. The flexibility of the spring 126 can be adjusted by moving the screw 128 on the post 124 of the corresponding connection structure 113. For example, the screw 128 of the corresponding connection structure 113 can be moved toward or away from the corresponding bridge structure 112 along the post 124. The flexibility of the spring 126 increases when the screw 128 is moved away from the bridge structure 112, resulting in an increase in the degree of rotation of the rotatable arm 110. The flexibility of the spring 126 decreases when the screw 128 is moved toward the bridge structure 112, resulting in a decrease in the degree of rotation of the rotatable arm 110. In some implementations, the spring 126 of the corresponding connection structure 113 is configured to reposition the rotatable arm 110 with respect to the second frame portion 106, as shown in FIG. 1B.

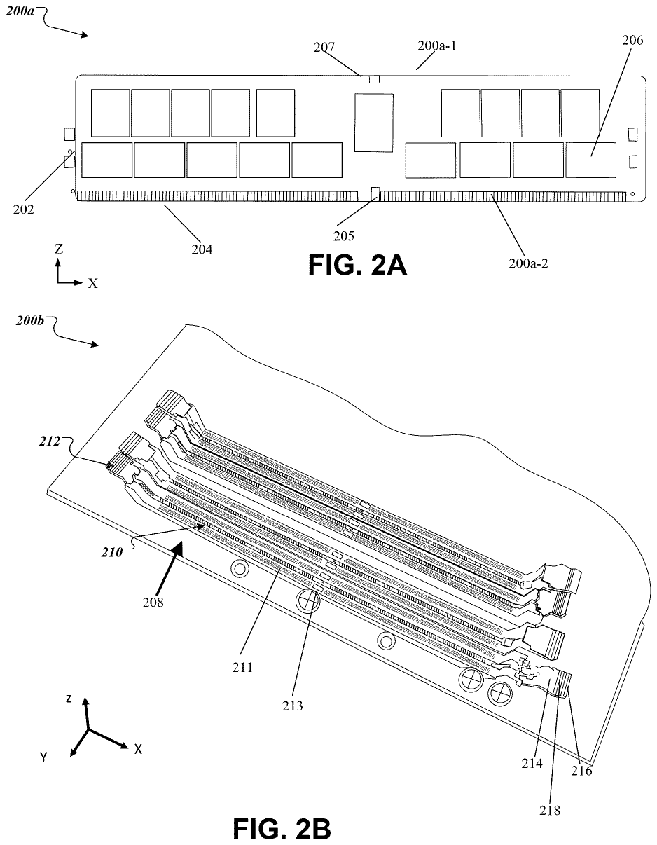

FIG. 2A is a perspective view of an example pluggable card 200a. FIG. 2B is a perspective view of an example computer board having sockets to hold pluggable cards.

The pluggable card 200a can be any suitable card used in a computer system, such as, but not limited to, a Dual In-line Memory Module (DIMM), a Small Outline Dual In-line Memory Module (SO-DIMM), Registered DIMM (RDIMM), Load Reduced DIMM (LR-DIMM), 3-Dimensional Stacking Registered DIMM (3DS-RDIMM), or Unbuffered DIMM (UDIMM). As shown in FIG. 2A, the pluggable card 200a can include one or more memory modules 206.

The pluggable card 200a has a first side 200a-1 and a second side 200a-2 opposite the first side 200a-1 along a vertical direction (e.g., Z direction). In some implementations, the first side 200a-1 of the pluggable card 200a can include a peripheral circuit 207. In some implementations, as shown in FIG. 2A, along the vertical direction, the peripheral circuit 207 is closer to the first side 200a-1 than the one or more memory modules 206. The second side 200a-2 of the pluggable card 200a can include metal pins 204. In some implementations, the metal pins 204 are used as signal transfer channels between the one or more memory modules 206 and a computer system through a socket (e.g., the socket 208 of FIG. 2B). In some examples, the number of metal pins 204 ranges from 70 to 300, depending on the application. For example, a third generation DIMM module can have 240 metal pins 204 on the second side 200a-2.

The pluggable card 200a also includes locking structures 202 on opposite sides of the pluggable card along a first horizontal direction (e.g., X direction) perpendicular to the vertical direction. The locking structures 202 can be used to secure the pluggable card 200a in the socket 208 shown in FIG. 2B. In some implementations, the notch 108 of the first frame portion 104 of the device 100 has a length greater than the length of the pluggable card 200a along the first horizontal direction. The width of the notch 108 of the first frame portion 104 of the device 100 is greater than the width of the pluggable card 200a along a second horizontal direction (e.g., Y direction) perpendicular to the first horizontal direction and the vertical direction. The depth of the notch 108 of the first frame portion 104 of the device 100 is smaller than the distance between the first side 200a-1 of the pluggable card 200a and an adjacent peripheral circuit 207 of the pluggable card 200a. The difference between the dimensions of the notch 108 of the first frame portion 104 and the pluggable card 200a can ensure that the pluggable card 200a is secured and maintained in an ideal direction and position to avoid the adjacent peripheral circuit 207 damaged by the first frame portion 104 during the assembly process of the pluggable card 200a into the socket 208. In some implementations, the depth of the notch 108 of the first frame portion 104 is in a range from 1 mm to 2 mm.

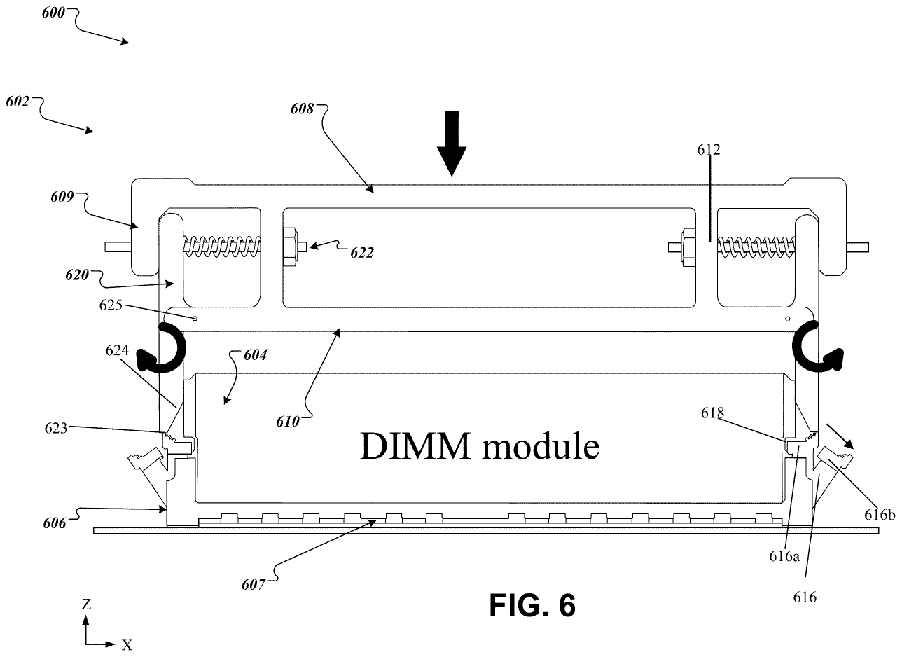

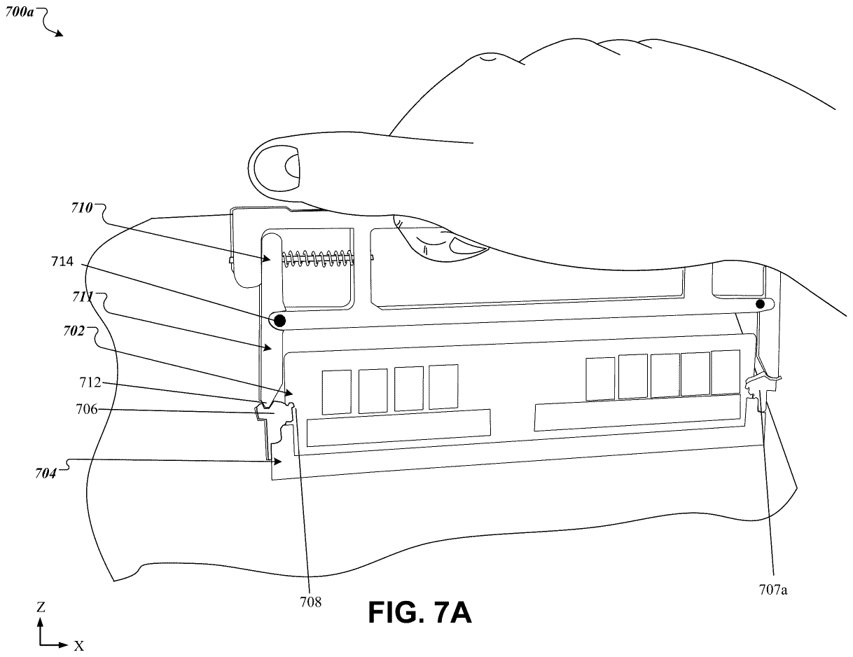

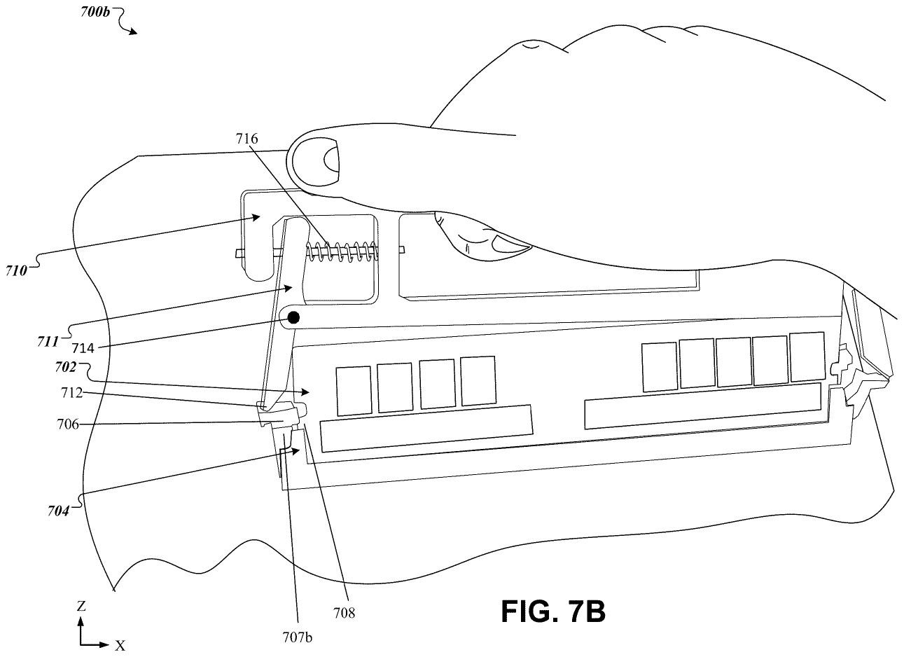

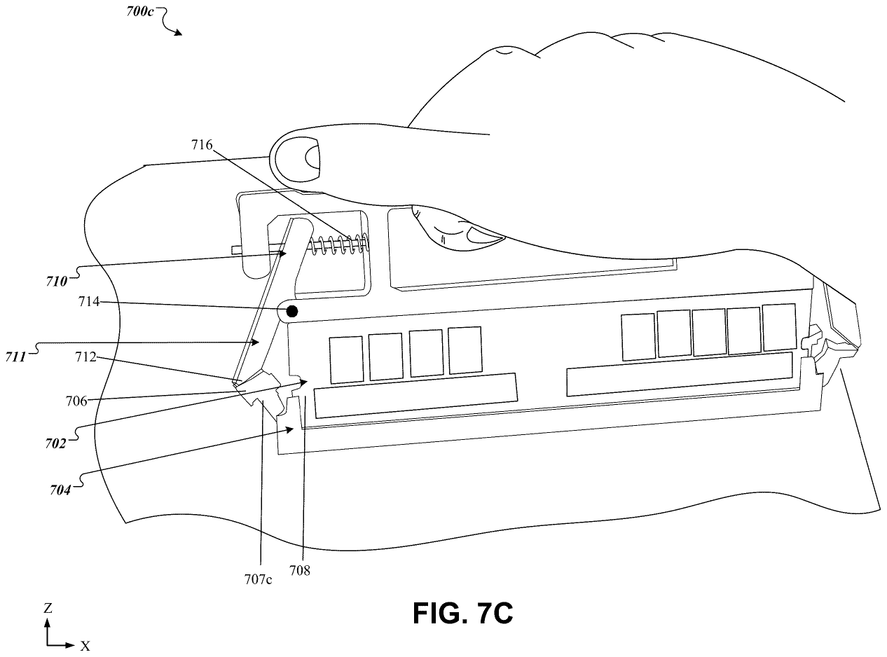

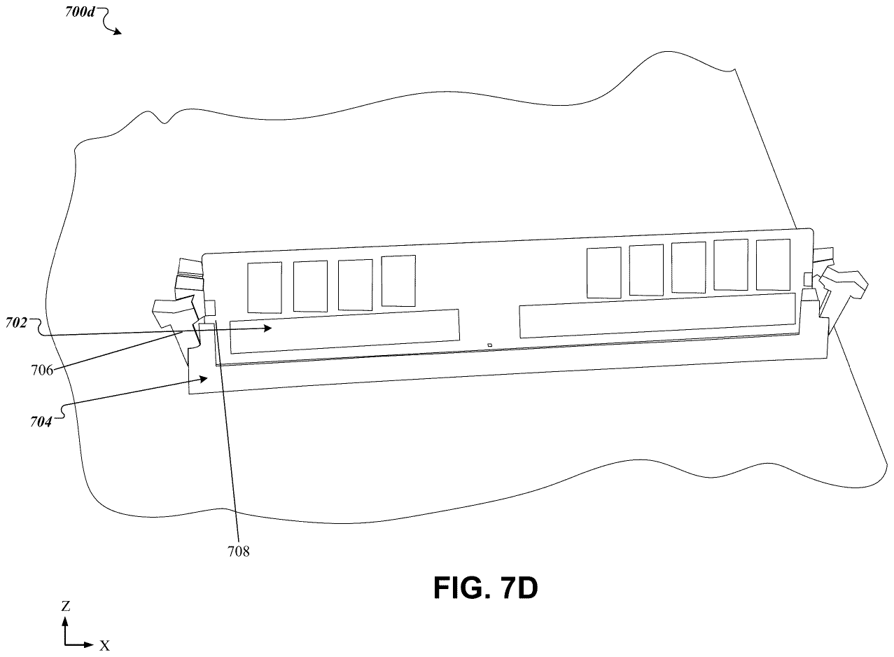

FIG. 2B is a perspective view of an example computer board 200b having sockets to hold pluggable cards. The computer board 200b can be any applicable electrical board, such as a printed circuit board (PCB) or a motherboard for a server computer. The computer board 200b can include one or more sockets 208. Each of the sockets 208 can be used to hold a pluggable card 200a. The device 100 of FIGS. 1A-1B is configured for assembling the pluggable card 100a into the socket 208. For example, the device 100 can be used to assemble the pluggable card 100a into the socket 208 with the notch 108 of the first frame portion 104 as shown in FIGS. 3 and 4A-4D. The device 100 of FIGS. 1A-1B is also configured for disassembling the pluggable card 200a from the socket 208. For example, the device 100 can be used to disassemble the pluggable card 200a from the socket 208 with the rotatable arms 110 as shown in FIGS. 6 and 7A-7D.

In some implementations, each of the sockets 208 can be used to transmit signals between the pluggable card 200a and the computer board 200b when the pluggable card 200a is assembled into the socket. The socket 208 can include a slot 210. The slot 210 is configured to hold the pluggable card 200a. For example, during the assembly process of the pluggable card 200a, the pluggable card 200a is inserted into the slot 210 of the socket 208. In some implementations, the slot 210 has metal contacts 211. The metal contacts 211 are configured to connect the metal pins 204 with the computer board 200b. The number of metal contacts 211 in the slot 210 is the same as the number of metal pins 204 on the pluggable card 200a. For example, the pluggable card 200a can be a DIMM with 240 metal pins 204. For each metal pin 204 on the DIMM, the slot 210 has metal contact s211 connected to the metal pins 204.

In some implementations, as shown in FIG. 2A, the metal pins 204 on the pluggable card 200a are arranged in an array with a void space 205 between the array of metal pins 204. As shown in FIG. 2B, the slot 210 has a corresponding filled structure 213 between the metal contacts 211. The void space 205 on the pluggable card 200a and the filled structure 213 in the slot 210 are used to align the pluggable card 200a and the slot 210 during the assembly process. For example, as shown in FIG. 2A, the void space 205 is slightly off-center in the array of metal pins 204 to ensure the pluggable card 200a is in the correct orientation when being inserted into the slot 210 of the socket 208.

As shown in FIG. 2B, the socket 208 includes two latches 212 at opposite ends of the socket 208. In some implementations, the two latches 212 are configured to lock the pluggable card 200a in the socket 208. For example, the two latches 212 of the socket 208 secure the locking structures 202 of the pluggable card 200a when the pluggable card 200a is assembled into the socket 208. The two latches 212 are configured to maintain a stable connection between the metal pins 204 of the pluggable card 200a and the metal contacts 211 of the socket 208 by securing the pluggable card 200a in a stationary position. In some implementations, the stable connection between the metal pins 204 of the pluggable card 200a and the metal contacts 211 of the socket 208 ensures signal transmission between the pluggable card 200a and the computer board 200b through the metal pins 204 and the metal contacts 211.

Each of the two latches 212 includes an inner end 214, an outer end 216, and a slope region 218 between the inner end 214 and the outer end 216. In some implementations, the slope region 218 of each of the two latches 212 and the sloped surface 138 of the rotatable arms 110 of the device 100 have opposite angles. For example, the slope region 218 has a positive angle with respect to the vertical direction (or the first direction such as Z direction), whereas the sloped surface 138 of the rotatable arms 110 has a negative angle with respect to the vertical direction. In some implementations, the device 100 is configured to disassemble the pluggable card 200a by using the tips 136 of the two rotatable arms 110 to push the slope regions 218 of the two latches 212, such that the pluggable card 200a is unlocked by the two latches 212. In some implementations, a first distance between the tips 136 of the two rotatable arms 110, as shown in FIG. 1B, is smaller than a second distance between the outer ends 216 of the two latches 212 of the socket 208 and greater than a third distance between the inner ends 214 of the two latches 212 of the socket 208. The difference between the first, second, and third distances can ensure the tips 136 of the two rotatable arms 110 land directly on the slope regions 218 of the two latches 212. In some implementations, the difference between the first distance and the second distance ranges from 1 mm to 3 mm. In some implementations, the length of the slope region 218 ranges from 1 mm to 3 mm. As illustrated in FIG. 2B, the slope region 218 can have a rough surface (e.g., a number of recesses along a third direction such as Y direction) to increase a friction between the tip 136 of the rotatable arm 110 and the latch 212 during the disassembly process.

FIG. 3 illustrates an example process 300 of assembling a pluggable card 304 into a socket 306 by an example device 302. The device 302 can be similar to, or the same as, the device 100 of FIGS. 1A-1B. The device 302 is configured to install the pluggable card 304 into a slot 307 of the socket 306. The pluggable card 304 can be similar to, or the same as, the pluggable card 200a of FIG. 2A. The socket 306 can be similar to, or the same as, the socket 208 of FIG. 2B. In some implementations, the pluggable card 304 can be a Dual In-line Memory Module (DIMM) and the socket 306 can be part of the computer motherboard that connects the pluggable card 304 to the computer motherboard. The socket 306 includes two latches 316 (e.g., the latches 212 of FIG. 2B) that are configured to rotate with respect to the slot 307.

As shown in FIG. 3, each of the two latches 316 can be moved from an open position 316a to a closed position 316b to secure the pluggable card 304 into the slot 307 of the socket 306 during the assembly process 300 of the pluggable card 304. In some implementations, each of the two latches 316 locks into a corresponding locking structure 318 of the pluggable card 304 when the two latches 316 are in the closed position to secure the pluggable card 304 into the slot 307 of the socket 306.

The device 302 includes a support frame 309 (e.g., the support frame 102 of FIGS. 1A-1B). The support frame 309 can include a first frame portion 308 (e.g., the first frame portion 104 of FIGS. 1A-1B) and a second frame portion 310 (e.g., the second frame portion 106 of FIGS. 1A-1B). The first frame portion 308 and the second frame portion 310 are connected together by one or more bridge structures 312 (e.g., the bridge structures 112 of FIGS. 1A-1B). The first frame portion 308 includes a first side 308-1 and a second side 308-2 that is connected to the second frame portion 310 by the one or more bridge structures 312. In some implementations, the first frame portion can include a notch (e.g., the notch 108 of FIG. 1A) that guides the pluggable card 304 into the slot 307 of the socket 306 during the assembly process 300.

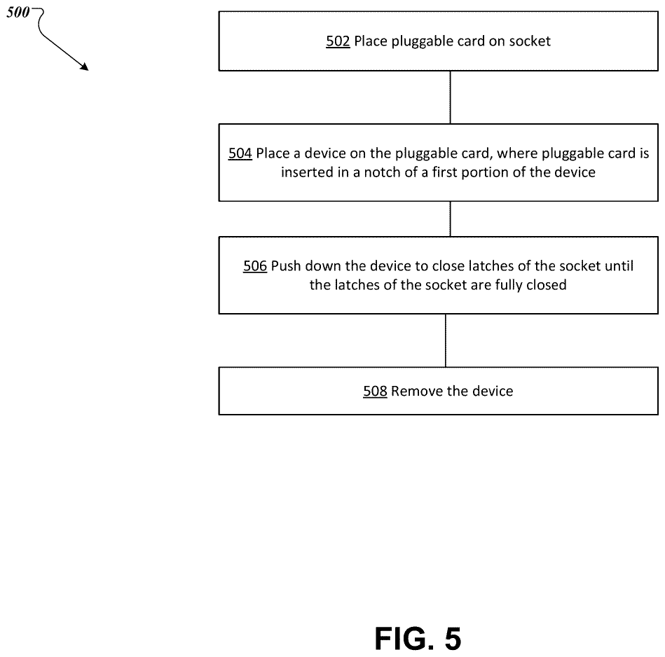

FIGS. 4A-4D illustrate steps 400a-400d for assembling a pluggable card into a socket by a device (e.g., the example device 302 of FIG. 3). The steps of FIG. 4A-4D can be performed by the device to install a pluggable card into a socket. FIG. 5 illustrates a flow chart 500 of an example process 500 of a method for assembling the pluggable card into the socket by the example device.

At operation 502, a pluggable card is placed into a socket. For example, as shown in step 400a of FIG. 4A, a pluggable card 402 is placed into a socket 406 on a computer board 404. The pluggable card 402 can be similar to or the same as the pluggable card 200a of FIG. 2A or 304 of FIG. 3. The socket 406 can be similar to or the same as the socket 208 of FIG. 2B or 306 of FIG. 3. In some implementations, the pluggable card 402 can include metal pins 403 (e.g., the metal pins 204 of FIG. 2A) that match a slot 405 (e.g., the slot 210 of FIG. 2B or 307 of FIG. 3) of the socket 406. The pluggable card 402 can include one or more memory modules 412 (e.g., the memory modules 206 of FIG. 2A) located away from an edge 414 of the pluggable card 402. In some implementations, the distance between the edge 414 and the one or more memory modules is at least 1 mm along a vertical direction (e.g., the Z direction). The pluggable card 402 also includes two locking structures 410 (e.g., the locking structures 202 of FIG. 2A) on opposite sides of the pluggable card 402 along a horizontal direction (e.g., the X direction) perpendicular to the vertical direction. The two locking structures 410 are configured to secure the pluggable card 402 into the socket 406. The socket 406 includes two latches 408 (e.g., the latches 212 of FIG. 2B or 316 of FIG. 3). In the open position 409a, as shown in FIG. 4A, the two latches 408 are open and not in contact with the pluggable card 402.

At operation 504, a device is placed on the pluggable card 402, where the pluggable card 402 is inserted into a notch of the first portion of the device. For example, as shown in step 400b of FIG. 4B, a user (e.g., an operator such as a human or a robot) can place a device 416 on the pluggable card 402, e.g., by using a hand such as a human hand or a robot hand. The device 416 can be similar to, or the same as, the device 100 of FIGS. 1A-1B or 302 of FIG. 3. The device 416 includes a support frame (e.g., the support frame 102 of FIG. 1B or 309 of FIG. 3) having a first frame portion 418 and a second frame portion. The first frame portion 418 can include a notch (e.g., the notch 108 of FIG. 1A). As shown in FIG. 4B, the edge 414 of the pluggable card is inserted into the notch of the first frame portion 418 of the device 416. The notch can be used to guide the pluggable card during the assembly process.

At operation 506, the device 416 is pushed down to close the latches of the socket until the latches are fully closed. For example, as shown in step 400c of FIG. 4C, the user can push the device 416 down to insert the pluggable card 402 into the socket 406 and close the latches 408 of the socket 406. As shown in FIG. 4C, the two latches 408 of the socket 406 move to a closed position 409b. In the closed position 409b, each of the two latches 408 lock onto a corresponding locking structure 410 of the pluggable card 402. In some implementations, the metal pins 403 of the pluggable card 402 are fully inserted into the slot 405 of the socket 406 when the two latches 408 are in the closed position 409b.

At operation 508, the device is removed. For example, as shown in step 400d of FIG. 4D, the user can remove the device 416 from the pluggable card 402 once the pluggable card 402 are fully inserted into the socket 406 and the two latches 408 of the socket 406 are at the closed position 409b.

FIG. 6 illustrates an example process 600 of disassembling a pluggable card from a socket using an example device 602. The device 602 can be similar to or the same as the device 100 of FIG. 1B, the device 302 of FIG. 3, or the device 416 of FIG. 4A-4D. The device 602 is configured to disassemble a pluggable card 604 from a slot 607 of the socket 606.

The pluggable card 604 can be similar to or the same as the pluggable card 200a of FIGS. 2A, 304 of FIG. 3, or 402 of FIGS. 4A-4D. The socket 606 can be similar to or the same as the socket 208 of FIGS. 2B, 306 of FIG. 3, or 406 of FIGS. 4A-4D. In some implementations, the pluggable card 604 can be a Dual In-line Memory Module (DIMM), and the socket 606 can be part of the computer motherboard that connects the pluggable card 604 to the computer motherboard. The socket 606 includes two latches 616 (e.g., the latches 212 of FIGS. 2B, 316 of FIG. 3, or 408 of FIGS. 4A-4D) that are configured to rotate with respect to the slot 607. As shown in FIG. 6, each of the two latches 616 can be moved from a closed position 616a to an open position 616b to release the pluggable card 604 from the slot 607 of the socket 606 during the disassembly process 600 of the pluggable card 604. In some implementations, in the closed position 616a, the two latches 616 lock the pluggable card 604 using two locking structures 618.

The device 602 includes a support frame 609 (e.g., the support frame 102 of FIGS. 1A-1B, 309 of FIG. 3, or the support frame of FIGS. 4A-4D). The support frame 609 can include a first frame portion 608 and a second frame portion 610. The first frame portion 608 and the second frame portion 610 are connected together by one or more bridge structures 612. As shown in FIG. 6, the device 602 also includes two rotatable arms 620. Each of the rotatable arms is coupled to the first frame portion 608 by a corresponding connection structure 622 and to the second frame portion 610 by a corresponding stabilizing pin 625. Each of the rotatable arms 620 is rotatable with respect to the second frame portion 610 around the stabilizing pin 625. Each of the two rotatable arms 620 includes a tip 623 and a sloped surface 624 extending from the tip 623. During the disassembly process of the pluggable card 604 from the socket 606, the tips 623 of the two rotatable arms 620 are in contact with the two latches 616 of the socket 606. The two latches 616 can be rotated from the closed position 616a to the open position 616b by rotating the two rotatable arms 620 with respect to the second frame portion 610 by applying an external force along the Z direction. In some implementations, the external force can be applied by a user holding the device 602, e.g., by using the user's hand such as a human hand or a robot hand.

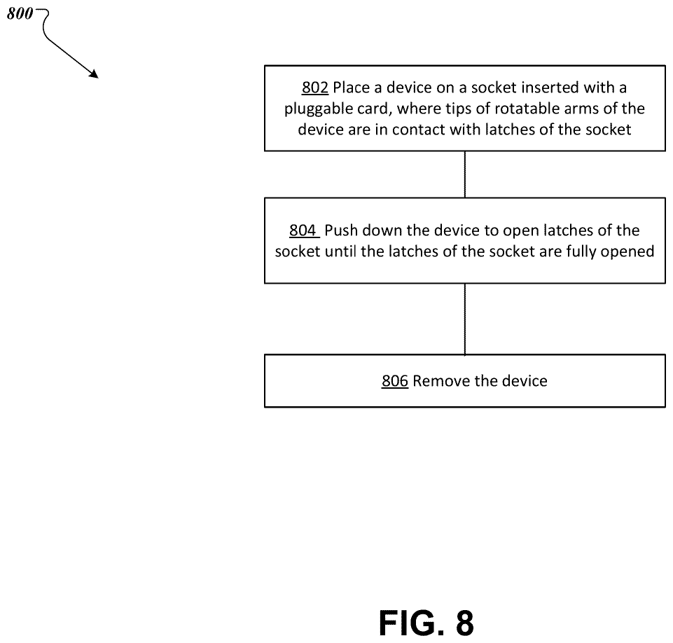

FIGS. 7A-7D illustrate steps 700a-700d for disassembling a pluggable card from a socket by the example device 602 of FIG. 6. The steps of FIG. 7A-7D can be performed by the device 100 of FIG. 1B to disassemble a pluggable card 200a of FIG. 2A from a socket 208 of FIG. 2B. FIG. 8 is a flow chart of an example process 800 of a method for disassembling a pluggable card from a socket by an example device.

At operation 802, a device is placed on a socket inserted with a pluggable card, where the tips of the rotatable arms of the device are in contact with the latches of the socket. For example, as shown in step 700a of FIG. 7A, a user can place the device 710 on the latches 706 of a socket 704. The device 710 can be similar to or the same as the device 100 of FIG. 1B. The device 710 can include two rotatable arms 711. Each of the two rotatable arms 711 has a tip 712 and is configured to rotate with respect to the stabilizing pin 714. In some implementations, the tips 712 are in contact with a corresponding latch 706 when the user places the device 710 on the socket 704. A pluggable card 702 is installed into the socket 704 and secured by the two latches 706 of the socket 704. As shown in FIG. 7A, the pluggable card 702 has two locking structures 708 at opposite ends of the pluggable card 702 along a horizontal direction (e.g., the X direction). When the latch 706 of the socket 704 is in a closed position 707a, the latches 706 are in contact with the pluggable card 702, where each of the latches 706 secures the pluggable card 702 by locking the locking structures 708.

At operation 804, the device is pushed down to open the latches of the socket until they are fully opened. As shown in step 700b of FIG. 7B, the user can push down the device 710 along a vertical direction (e.g., the Z direction) perpendicular to the X direction, causing the rotatable arms 711 to rotate outward. For example, as shown in FIG. 7B, the tip 712 of each rotatable arm 711 moves away from the device 710 when the rotatable arm 711 rotates outward with respect to the stabilizing pin 714. The movement of the tip 712 pushes a corresponding latch 706 outward to an intermediate position 707b, where the latches 706 move away from the locking structures 708 of the pluggable card 702.

FIG. 7C illustrates step 700c of the disassembly process for the pluggable card 702. As the user pushes down on the device 710 along the Z direction, the rotatable arms 711 rotate outward until they are limited by a spring 716 of the device 710. This results in a maximum displacement of the tips 712 of the rotatable arms 711, which pushes the latches 706 to an open position 707c. As shown in FIG. 7C, the latches 706 of the socket are fully opened to the open position 707c by the movement of the tips 712 of the rotatable arms 711. In the open position 707c, the latches 706 are detached from the locking structures 708 of the pluggable card 702, allowing the pluggable card 702 to be released from the socket 704.

At operation 806, the device is removed, and the pluggable card can be disassembled. For example, as shown in step 700d of FIG. 7D, the user can remove the device 710 from the socket 704. The pluggable card 702 is released by the socket 704, and the user can disassemble the pluggable card 702 from the socket 704.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results.

Accordingly, the previously described example implementations do not define or constrain the present disclosure. Other changes, substitutions, and alterations are also possible without departing from the scope of the present disclosure.

What is claimed is:

1. A device, comprising:
a support frame having a first frame portion and a second frame portion, wherein the first frame portion comprises a first side and a second side that are opposite to each other, the first side of the first frame portion comprising a notch, the second side of the first frame portion being connected to the second frame portion;
rotatable arms, wherein each of the rotatable arms is coupled to the first frame portion and the second frame portion; and
connection structures, wherein each of the rotatable arms is coupled to the first frame portion through a respective connection structure of the connection structures,
wherein each of the rotatable arms is rotatable with respect to the second frame portion.

2. The device of claim 1, wherein the rotatable arms comprise two rotatable arms coupled to two opposite ends of the second frame portion, and
wherein a distance of ends of the two rotatable arms varies when the two rotatable arms are rotating with respect to the two opposite ends of the second frame portion.

3. The device of claim 1, wherein the support frame further comprises one or more bridge structures coupled between the first frame portion and the second frame portion.

4. The device of claim 3, wherein the first frame portion, the second frame portion, and the one or more bridge structures are integrated into a single piece to form the support frame.

5. The device of claim 3, wherein each of the one or more bridge structures extends along a first direction, and the second side of the first frame portion is connected to the second frame portion by the one or more bridge structures along the first direction, and
wherein the notch in the first side of first frame portion extends along a second direction perpendicular to the first direction, and the first frame portion comprises two connection portions each extending along the first direction, wherein the two connection portions are at opposite ends of the first frame portion along the second direction, and the one or more bridge structures are between the two connection portions along the second direction.

6. The device of claim 5, wherein the rotatable arms comprise two rotatable arms each comprising a through hole,
wherein the one or more bridge structures comprise two bridge structures each comprising an inner connection hole,
wherein each of the two connection portions comprises an outer connection hole, and
wherein each of the two rotatable arms is coupled to a corresponding connection portion of the first frame portion and to a corresponding bridge structure by a corresponding connection structure through the outer connection hole, the through hole, and the inner connection hole that are aligned with each other along the second direction.

7. The device of claim 6, wherein the corresponding connection structure comprises a spring, a post, and a screw, and
wherein the post of the corresponding connection structure extends sequentially through the outer connection hole, the through hole, and the inner connection hole along the second direction, and
wherein the screw of the corresponding connection structure secures the corresponding connection structure to the support frame.

8. The device of claim 7, wherein the spring of the corresponding connection structure is arranged between the through hole of the rotatable arm and the inner connection hole of the corresponding bridge structure, and
wherein the rotatable arm is movable along the post of the corresponding connection structure with respect to the corresponding connection portion of the first frame portion and the corresponding bridge structure while the rotatable arm is rotating with respect to the second frame portion.

9. The device of claim 8, wherein a degree of rotation of the rotatable arm is determined by a flexibility of the spring between the rotatable arm and the corresponding bridge structure, a distance between the rotatable arm and the corresponding bridge structure is adjustable by moving the screw on the post of the corresponding connection structure.

10. The device of claim 7, wherein the spring of the corresponding connection structure is configured to reposition the rotatable arm with respect to the second frame portion.

11. The device of claim 5, wherein the second frame portion comprises two opposite ends along the second direction, each opposite end comprising a stabilizing hole,
wherein the rotatable arms comprise two rotatable arms each comprising a rotating hole,
wherein the device further comprises two stabilizing pins that connect the two rotatable arms to the second frame portion of the support frame,
wherein each of the two stabilizing pins extends through the stabilizing hole of a corresponding end of the second frame portion and the rotating hole of a corresponding rotatable arm, and
wherein a corresponding rotatable arm is configured to rotate around the stabilizing pin with respect to the second frame portion.

12. The device of claim 1, wherein the device is configured for at least one of:
assembling a pluggable card into a socket, or
disassembling the pluggable card from the socket,
wherein the socket comprises two latches at opposite end of the socket, and the two latches are configured to lock the pluggable card in the socket.

13. The device of claim 12, wherein the rotatable arms comprise two rotatable arms each having a first end coupled to the first frame portion, a middle part coupled to the second frame portion, and a second end having a tip and a slope surface extending from the tip, and
wherein the slope surfaces of the two rotatable arms face to each other.

14. The device of claim 13, wherein each of the two latches comprises an inner end, an outer end, and a slope region between the inner end and the outer end, and
wherein the device is configured to disassemble the pluggable card by using the tips of the two rotatable arms to push the slope regions of the two latches such that the pluggable card is unlocked by the two latches.

15. The device of claim 14, wherein a first distance between the tips of the two rotatable arms is smaller than a second distance between the outer ends of the two latches of the socket and greater than a third distance between the inner ends of the two latches of the socket.

16. The device of claim 12, wherein the notch of the first frame portion has:
a length greater than a length of the pluggable card,
a width greater than a width of the pluggable card,
a depth smaller than a distance between an edge of the pluggable card and an adjacent peripheral circuit or component of the pluggable card.

17. A method of assembling a pluggable card into a socket by a device, the method comprising:
placing the pluggable card on the socket;
placing the device on the pluggable card, wherein the pluggable card is inserted in a notch of the device, and wherein the device comprises a support frame having a first frame portion and a second frame portion, wherein the first frame portion comprises a first side and a second side that are opposite to each other, the first side of the first frame portion comprising the notch, the second side of the first frame portion being connected to the second frame portion;
pushing down the device to assemble the pluggable card on the socket; and
removing the device from the pluggable card.

18. The method of claim 17, wherein the socket comprises two latches at opposite ends of the socket, and
wherein pushing down the device to assemble the pluggable card on the socket comprises:
pushing down the pluggable card by the device to close the two latches of the socket to lock the pluggable card into the socket.

19. A method of disassembling a pluggable card from a socket by a device, the method comprising:
placing the device on two latches of the socket that lock the pluggable card on the socket, the device comprising two rotatable arms;
pushing down the device to open the two latches of the socket using the two rotatable arms to unlock the pluggable card from the socket; and
removing the device.

20. The method of claim 19, wherein each of the two latches comprises an inner end, an outer end, and a slope region between the inner end and the outer end, and wherein each of the two rotatable arms comprises a tip,
wherein placing the device on the two latches of the socket comprises: placing the tips of the two rotatable arms of the device in contact with the two latches of the socket, and
wherein pushing down the device to open the two latches of the socket to unlock the pluggable card comprises pushing down the device, wherein the two rotatable arms rotate outward to open the two latches of the socket.
